(19) United States
(12) Patent Application Publication
(10) Pub. No.: US 2026/0341165 A1
(43) Pub. Date: Oct. 29, 2026

(54) DANCE PRACTICE SYSTEM, DANCE PRACTICE METHOD, AND RECORDING MEDIUM

(71) Applicant: Panasonic Intellectual Property Management Co., Ltd., Osaka (JP)

(72) Inventors: Chikara GOTANDA, Osaka (JP); Tsuyoshi SAITOH, Nara (JP)

(21) Appl. No.: 19/104,975

(22) PCT Filed: May 29, 2023
(86) PCT No.: PCT/JP2023/019957

§ 371 Date: Feb. 19, 2025

(30) Foreign Application Priority Data
Sep. 7, 2022 (JP) 2022-142557

(51) Int. Cl. G09B 5/02; G06T 11/60; G06T 13/00

(52) U.S. Cl. CPC G09B 5/02; G06T 11/60; G06T 13/00; G06T 2210/36

(57) ABSTRACT

A dance practice system includes a first input I/F, a second input I/F, a processor, and an output I/F. The processor generates guide image data instructing a user to make movement of the user more closely resemble movement of a performer. The processor determines which of a plurality of frames of model image data corresponds to a specific frame obtained at a predetermined point in time from among a plurality of frames of user image data. When the specific frame is later than the frame determined, the processor causes the guide image data to be displayed on a display earlier as a time difference between the frame determined and the specific frame is greater.

### TECHNICAL FIELD

The present disclosure relates to a dance practice system and the like for assisting dance practice by a user.

### BACKGROUND ART

Patent Literature (PTL) 1, for example, discloses an image generation device that presents, to a subject who dances, an ideal dance image as a virtual image of the subject him/herself.

### CITATION LIST

### Patent Literature

PTL 1: International Publication No. 2021/039857

### SUMMARY OF INVENTION

### Technical Problem

With the image generation device disclosed in PTL 1, an ideal dance image can be presented to the user as a virtual image of the user him/herself, but just because the user views the image when practicing their dance does not mean that the user can dance in the same way the image shows. In other words, the image generation device disclosed in PTL 1 has an issue in that the user's dance proficiency cannot be expected to improve when the user practices their dance.

The present disclosure provides a dance practice system and the like that facilitate the improvement of dance proficiency when a user practices a dance.

### Solution to Problem

A dance practice system according to one aspect of the present disclosure includes a first input interface, a second input interface, a signal processing circuit, and an output interface. The first input interface obtains user image data that is based on image data generated by capturing an image using a camera and that includes a plurality of frames indicating movement of a user. The second input interface obtains model image data including a plurality of frames indicating movement of a performer serving as a model for a dance. The signal processing circuit generates guide image data instructing the user to make the movement of the user more closely resemble the movement of the performer. The output interface causes the user image data, the model image data, and the guide image data to be displayed on a display. The signal processing circuit determines which of the plurality of frames of the model image data corresponds to a specific frame obtained at a predetermined point in time from among the plurality of frames of the user image data. When the specific frame is later than the frame determined from among the plurality of frames of the model image data, the signal processing circuit causes the guide image data to be displayed on the display earlier as a time difference between the frame determined and the specific frame is greater.

In a dance practice method according to one aspect of the present disclosure, user image data that is based on image data generated by capturing an image using a camera and that includes a plurality of frames indicating movement of a user is obtained. In the dance practice method, model image data including a plurality of frames indicating movement of a performer serving as a model for a dance is obtained. In the dance practice method, guide image data instructing the user to make the movement of the user more closely resemble the movement of the performer is generated. In the dance practice method, the user image data, the model image data, and the guide image data are displayed on a display. In the generating of the guide image data, which of the plurality of frames of the model image data corresponds to a specific frame obtained at a predetermined point in time from among the plurality of frames of the user image data is determined. In the generating of the guide image data, when the specific frame is later than the frame determined from among the plurality of frames of the model image data, the guide image data is caused to be displayed on the display earlier as a time difference between the frame determined and the specific frame is greater.

A program according to one aspect of the present disclosure causes at least one processor to execute the dance practice method.

### Advantageous Effects of Invention

The dance practice system and the like according to the present disclosure have an advantage in that an improvement in dance proficiency when a user practices a dance is facilitated.

### BRIEF DESCRIPTION OF DRAWINGS

FIG. 1 is a block diagram illustrating an example of an overall configuration including a dance practice system according to an embodiment.

FIG. 2 is a schematic diagram illustrating an example of the use of the dance practice system according to the embodiment.

FIG. 3 is a schematic diagram illustrating an example of guide image data.

FIG. 4 is a flowchart illustrating an example of processing by an analyzer according to the embodiment.

FIG. 5 is an explanatory diagram illustrating operations performed by the analyzer according to the embodiment.

FIG. 6 is a flowchart illustrating an example of processing by a corrector according to the embodiment.

FIG. 7 is an explanatory diagram illustrating operations performed by the corrector according to the embodiment.

FIG. 8 is a flowchart illustrating an example of processing by a generator according to the embodiment.

FIG. 9 is an explanatory diagram illustrating Specific Example 1 of the dance practice system according to the embodiment.

FIG. 10 is an explanatory diagram illustrating Specific Example 2 of the dance practice system according to the embodiment.

### DESCRIPTION OF EMBODIMENTS

An embodiment will be described in detail hereinafter with reference to the drawings. The following embodiment will describe general or specific examples. The numerical values, shapes, materials, constituent elements, arrangements and connection states of constituent elements, steps, orders of steps, and the like in the following embodiment are merely examples, and are not intended to limit the present disclosure. Additionally, of the constituent elements in the following embodiment, constituent elements not denoted in the independent claims will be described as optional constituent elements.

Note also that the drawings are schematic diagrams, and are not necessarily exact illustrations. Configurations that are substantially the same are given the same reference signs in the drawings, and redundant descriptions may be omitted or simplified.

### EMBODIMENT

### 1. Configuration

### [1-1. Overall Configuration]

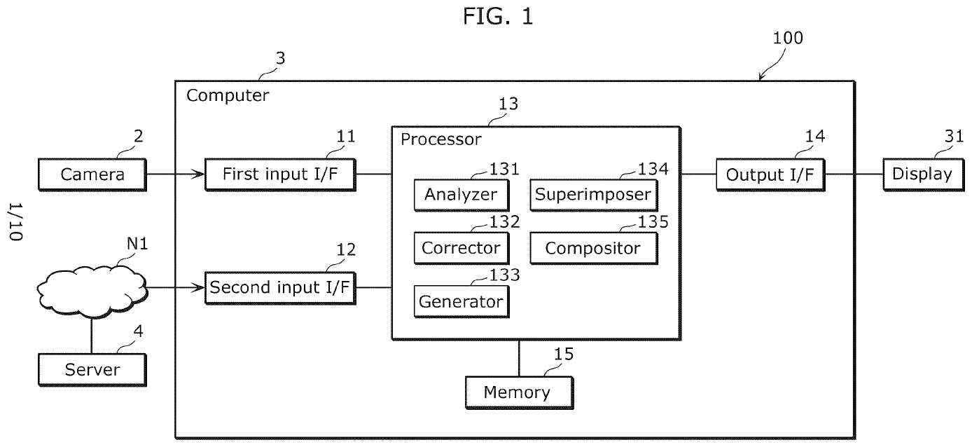

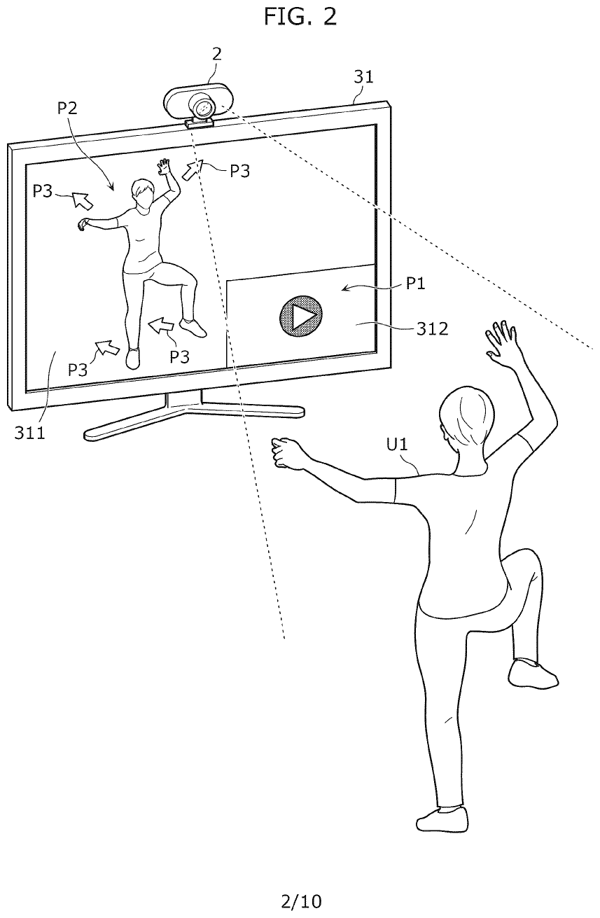

An overall configuration including a dance practice system according to an embodiment will be described first with reference to FIG. 1. FIG. 1 is a block diagram illustrating an example of the overall configuration including the dance practice system according to the embodiment. Dance practice system 100 is a system for assisting user U1 (see FIG. 2) to become capable of imitating the movements of a performer serving as a model for a dance when user U1 practices the dance. Here, “dance” refers to a series of movements performed to an accompaniment, for example. Note that “dance” also includes dances without music, in which the movement of the body itself functions as an accompaniment. In the embodiment, dance practice system 100 is installed in computer 3, which is a personal computer or the like. In other words, in the embodiment, dance practice system 100 includes computer 3. Note that dance practice system 100 may further include at least one of camera 2, display 31, and server 4 (described later) in addition to computer 3.

FIG. 2 is a schematic diagram illustrating an example of the use of dance practice system 100 according to the embodiment. As illustrated in FIG. 2, computer 3 displays model image data P1, user image data P2, and guide image data P3 on display 31 provided separate from computer 3. Camera 2 is attached to the top of a bezel of display 31 for capturing images of user U1 directly opposite display 31.

Camera 2 includes an image sensor such as a Charge Coupled Device (CCD) sensor or a Complementary Metal Oxide Semiconductor (CMOS) sensor, for example, and captures an image of user U1 directly opposite display 31. Camera 2 generates pre-correction image data by capturing an image of user U1, and outputs the generated pre-correction image data to first input interface (referred to as “I/F” (“interface”) hereinafter) 11 of dance practice system 100 (described later). User image data P2 is generated by processor 13 of dance practice system 100 (described later) correcting the pre-correction image data. Although camera 2 is attached to display 31 in advance in the embodiment, camera 2 need not be attached in advance, and may be retrofitted instead.

Model image data P1 is image data indicating movement of a performer serving as a model for a dance, and is moving image data including a plurality of frames. In the embodiment, model image data P1 is moving image data for a single performer performing the movement serving as the model mentioned above. In addition, in the embodiment, model image data P1 is video content that has been created in advance and that shows the performer performing the movement serving as the model mentioned above. Here, in the embodiment, model image data P1 is moving image data obtained by capturing an image from the front of the performer while the performer is performing a movement horizontally inverted with respect to the movement serving as the model mentioned above. For example, a movement of raising the right hand in the movement serving as the model mentioned above is a movement of raising the left hand in model image data P1 displayed on display 31.

User U1 practices a dance by looking at model image data P1 displayed on display 31 and imitating the movement of the performer directly (i.e., performing a movement that mirrors the movement serving as the model). For example, if the performer in model image data P1 displayed on display 31 raises their left hand, i.e., the performer raises their right hand as seen from user U1, user U1 raises their right hand to imitate that movement. Here, as will be described later, user image data P2 is captured, by camera 2, of user U1 directly opposite display 31, and the captured pre-correction image data is displayed on display 31 in a horizontally-inverted manner. Accordingly, the image is displayed on display 31 such that the performer in model image data P1 and user U1 in user image data P2 are performing the same movement. For example, if user U1 raises their right hand to imitate the performer raising their right hand as displayed on display 31, user U1 will raise their right hand in user image data P2 displayed on display 31 as well.

In the embodiment, model image data P1 is delivered from server 4 (described later) over network N1, which is the Internet or the like. In the embodiment, processor 13 of dance practice system 100 obtains model image data P1 from server 4 in advance, and analyzes model image data P1 obtained. Processor 13 of dance practice system 100 then stores information including model image data P1 obtained and the result of analyzing model image data P1 in memory 15. In the embodiment, dance practice system 100 also displays model image data P1 stored in memory 15 on display 31 when the user practices a dance.

If moving image data is obtained by capturing an image from in front of the performer directly while the performer is performing the movement serving as the model mentioned above, when that moving image data is obtained, processor 13 of dance practice system 100 may horizontally invert the obtained moving image data and obtain the inverted moving image data as model image data P1.

In the embodiment, model image data P1 is displayed on display 31 at a framerate of 30 or 60 frame per second (fps). Note that the framerate may be a number other than 30 fps or 60 fps. In the embodiment, model image data P1 is displayed in what is the lower-right corner of display 31, at a size smaller than the size of user image data P2. The region in which model image data P1 is displayed on display 31 will also be called “sub-screen 312” hereinafter.

User image data P2 is image data indicating movement of user U1, based on image data generated by capturing an image of user U1 using camera 2, and is moving image data constituted by a plurality of frames. In the embodiment, user image data P2 is displayed on display 31 at the same framerate as model image data P1.

In the embodiment, user image data P2 is also displayed on display 31 as a mirror image of user U1 directly opposite display 31. Specifically, user image data P2 is generated by processor 13 of dance practice system 100 executing processing for horizontally inverting image data on the pre-correction image data input to first input I/F 11 of dance practice system 100 from camera 2.

In the embodiment, user image data P2 is displayed in what is the center of display 31, at a size larger than the size of sub-screen 312. The region in which user image data P2 and guide image data P3 are displayed on display 31 will also be called “main screen 311” hereinafter.

Guide image data P3 is image data instructing user U1 to make the movement of user U1 more closely resemble the movement of the performer, and is moving image data including a plurality of frames. Guide image data P3 includes arrows indicating the next movement to be performed by user U1, as illustrated in FIG. 2, for example. In the example illustrated in FIG. 2, user U1 moves the right hand, the right foot, the left hand, and the left foot, respectively, in accordance with arrows located near the right hand, the right foot, the left hand, and the left foot, respectively, on display 31. By performing the movements while looking at guide image data P3, user U1 can understand the next movement to be performed even if they do not remember the movement of the performer, and can therefore make their movement more closely resemble the movement serving as a model for the dance.

In the embodiment, the framerate when displaying guide image data P3 on display 31 is the same as the framerate when displaying user image data P2 on display 31. Like user image data P2, guide image data P3 is updated for each frame and displayed on display 31. In the embodiment, guide image data P3 is also displayed on display 31, superimposed over user image data P2 in main screen 311. Note that guide image data P3 need not be updated every frame, and may be updated every several frames, for example.

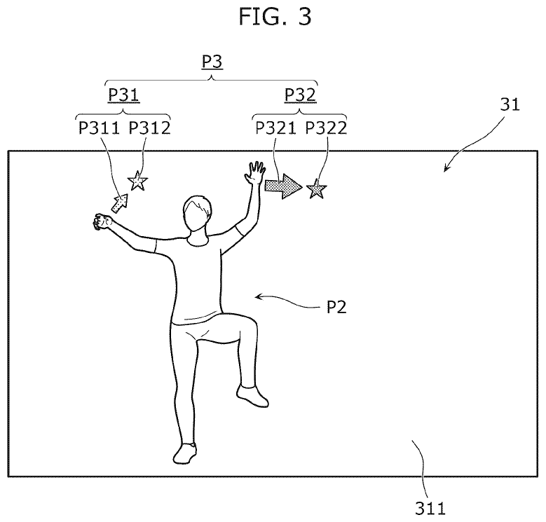

FIG. 3 is a schematic diagram illustrating an example of guide image data P3. Of main screen 311 and sub-screen 312 displayed on display 31, only main screen 311 is illustrated in FIG. 3. As illustrated in FIG. 3, guide image data P3 is displayed superimposed over user image data P2 in main screen 311. In the example illustrated in FIG. 3, guide image data P3 includes image data P31 corresponding to the left hand of user U1 and image data P32 corresponding to the right hand of user U1. Image data P31 includes arrival point P312 indicating a position where the left hand of user U1 should arrive at next, and arrow P311 indicating a direction and a movement amount for user U1 to move the left hand from the current position to the arrival point. Image data P32 includes arrival point P322 indicating a position where the right hand of user U1 should arrive at next, and arrow P321 indicating a direction and a movement amount for user U1 to move the right hand from the current position to the arrival point. In other words, in the embodiment, guide image data P3 includes an arrival point indicating a position where user U1 should arrive next on display 31, and an arrow indicating a direction and a movement amount from the current position of user U1 to the arrival point on display 31, for each part of user U1. Note that guide image data P3 may include an arrival point and arrow for the entire body of user U1, rather than each part of user U1.

In the embodiment, the arrival points and arrows in guide image data P3 are displayed darker on display 31 as the movement amount when moving each part of user U1 from the current position to the arrival point is greater, and lighter as the movement amount is smaller. Additionally, in the embodiment, the arrows in guide image data P3 are displayed on display 31 at a larger size as the movement amount is greater, and at a smaller size as the movement amount is smaller. Here, the “arrow size” includes the length of the arrow. In other words, the arrows in guide image data P3 are displayed on display 31 longer as the movement amount is greater, and shorter as the movement amount is smaller. In other words, at least one of the size and the darkness of guide image data P3 is changed according to a difference between the movement of user U1 and the movement of the performer.

User U1 can practice the dance by imitating the movement serving as a model for the dance while viewing model image data P1 displayed on display 31. Also viewing user image data P2 indicating their own movement and guide image data P3 makes it easier for user U1 to make their movement more closely resemble the movement of the performer, and enables user U1 to practice the dance more efficiently.

### [1.2. Configuration of Dance Practice System]

The configuration of dance practice system 100 will be described in detail next. As illustrated in FIG. 1, dance practice system 100 includes first input I/F 11, second input I/F 12, processor 13, output I/F 14, and memory 15.

First input I/F 11 is a wired communication interface, for example, and is connected to camera 2 using a cable such as a Universal Serial Bus (USB) cable. First input I/F 11 obtains the pre-correction image data from camera 2 by communicating with camera 2 over a wire. Note that first input I/F 11 may be a wireless communication interface. In this case, first input I/F 11 obtains the pre-correction image data from camera 2 by communicating with camera 2 over a network such as a Local Area Network (LAN) based on a wireless communication standard such as Wi-Fi (registered trademark).

In the embodiment, processor 13 generates user image data P2 by executing processing for horizontally inverting the pre-correction image data on the pre-correction image data obtained by first input I/F 11. In other words, first input I/F 11 indirectly obtains user image data P2 by obtaining the pre-correction image data.

Second input I/F 12 is a wireless communication interface, for example, and obtains model image data P1 from server 4, which provides a moving image delivery service, over network N1, which is the Internet or the like, based on a wireless communication standard such as Wi-Fi (registered trademark). The moving image delivery service is, for example, YouTube (registered trademark)), Instagram (registered trademark)), TikTok (registered trademark), or the like.

Note that second input I/F 12 may obtain model image data P1 stored in an information terminal such as a smartphone held by user U1, or may obtain model image data P1 stored in an external storage device such as a hard disk drive (HDD) held by user U1. When obtaining model image data P1 from an information terminal or an external storage device, second input I/F 12 may obtain model image data P1 by wired communication with the information terminal or external storage device using a cable such as a USB cable.

Processor 13 is a Central Processing Unit (CPU) or the like, for example, and performs information processing such as generating guide image data P3 based on user image data P2 obtained through first input I/F 11 and model image data P1 obtained through second input I/F 12. The information processing is implemented by processor 13 executing computer programs stored in memory 15. Processor 13 is an example of a signal processing circuit of dance practice system 100.

In the embodiment, processor 13 functions as analyzer 131, corrector 132, generator 133, superimposer 134, and compositor 135 by executing computer programs stored in memory 15 by processor 13.

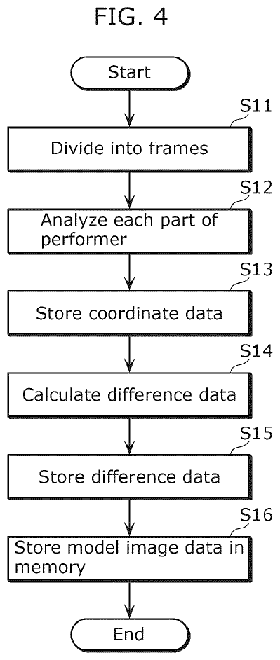

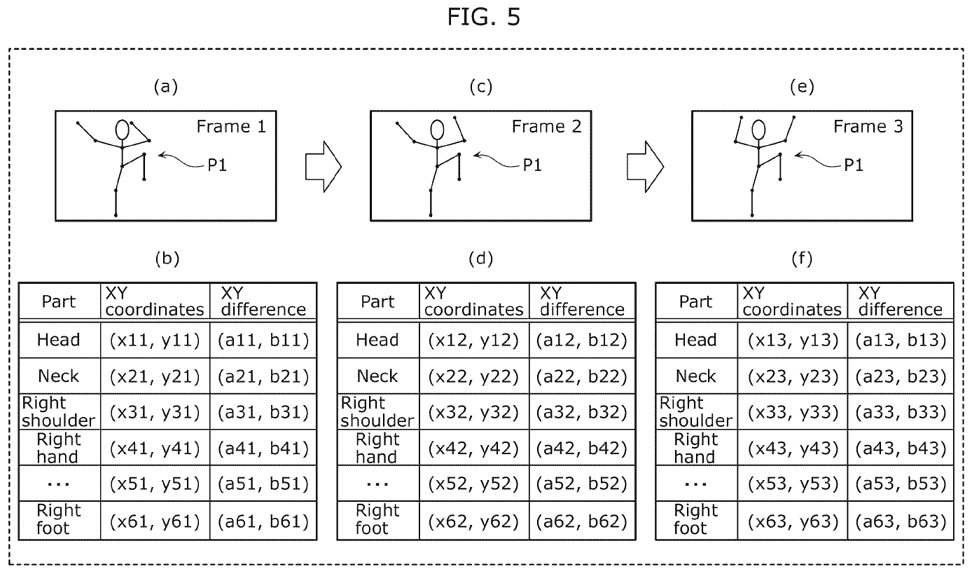

Analyzer 131 analyzes model image data P1 obtained through second input I/F 12. In the embodiment, the analysis of model image data P1 by analyzer 131 is performed before displaying model image data P1 on display 31. In other words, in the embodiment, model image data P1 is displayed on display 31 after the analysis of model image data P1 by analyzer 131 is complete. The specific processing performed by analyzer 131 will be described hereinafter with reference to FIGS. 4 and 5.

FIG. 4 is a flowchart illustrating an example of the processing by analyzer 131 according to the embodiment. First, analyzer 131 divides model image data P1 obtained through second input I/F 12 into frames (S11). Each frame obtained from the dividing is assigned a frame number, with the frame at the start of model image data P1 being the first frame. Hereinafter, model image data P1 obtained in advance will be assumed to have N frames (where N is a natural number), and an n-th frame (where n is a natural number, and 1≤n≤N) to be processed will be called “frame n”.

Next, for each frame, analyzer 131 calculates coordinate data L1 (n) of each part of the performer by analyzing each part of the performer (S12). Here, “coordinate data” is data representing coordinates in an XY plane in the image data of the frame (i.e., coordinates in a two-dimensional Cartesian coordinate system). Coordinate data L1 (n) of each part of the performer calculated by analyzer 131 is stored in memory 15 for each frame (S13). In other words, coordinate data L1 (1), L1 (2), and so on up to L1 (N) are stored in memory 15.

In step S12, analyzer 131 calculates coordinate data L1 (n) of each part of the performer using a suitable algorithm for detecting skeletal coordinates of a human figure included in image data, such as Kinect (registered trademark). In the embodiment, analyzer 131 calculates coordinate data of each of the performer's head, neck, right shoulder, left shoulder, right hand, left hand, right foot, and left foot in each frame, and these coordinate data are coordinate data L1 (n). Note that the parts of the performer given above are examples, and analyzer 131 may calculate coordinate data for other parts of the performer. The number of types of parts of the performer analyzed by analyzer 131 may be greater than or less than the number of parts given above.

Next, for each frame, analyzer 131 calculates difference data D1 (n) between coordinate data L1 (n) of each part of the performer in the frame and coordinate data L1 (n +1) of each part of the performer in the following frame (S14). Difference data D1 (n) is calculated by subtracting coordinate data L1 (n) from coordinate data L1 (n+1). Difference data D1 (n) calculated by analyzer 131 is stored in memory 15 for each frame (S15). In other words, difference data D1 (1), D1 (2), and so on up to D1 (N−1) are stored in memory 15.

FIG. 5 is an explanatory diagram illustrating operations performed by analyzer 131 according to the embodiment. (a) of FIG. 5 indicates “frame 1” of model image data P1, and (b) of FIG. 5 indicates coordinate data L1 (1) of each part of the performer obtained by analyzing “frame 1” of model image data P1. (c) of FIG. 5 indicates “frame 2” of model image data P1, and (d) of FIG. 5 indicates coordinate data L1 (2) of each part of the performer obtained by analyzing “frame 2” of model image data P1. (e) of FIG. 5 indicates “frame 3” of model image data P1, and (f) of FIG. 5 indicates coordinate data L1 (3) of each part of the performer obtained by analyzing “frame 3” of model image data P1. In each of (b), (d), and (f) of FIG. 5, “part” indicates the part of the performer, “XY coordinates” indicates the coordinate data of each part of the performer in the frame, and “XY difference” indicates the difference between the coordinate data of each part of the performer in the frame and the coordinate data of each part of the performer in the following frame. Note that in FIG. 5, the performer is represented only by a skeleton. The performer is represented only by a skeleton in the following drawings as well.

In FIG. 5, for example, difference data (a12, b12) of the head of the performer in “frame 2” of model image data P1 is the difference between coordinate data (x12, y12) of the head of the performer in “frame 2” of model image data P1 and coordinate data (x13, y13) of the head of performer in “frame 3” of model image data P1. In other words, difference data D1 (2) is calculated by subtracting coordinate data L1 (2) of each part of the performer in “frame 2” of model image data P1 from coordinate data L1 (3) of each part of the performer in “frame 3” of model image data P1.

Analyzer 131 also stores model image data P1 in memory 15 (S16). Step S16 may be executed in parallel with steps S11 to S15, or may be executed before step S11.

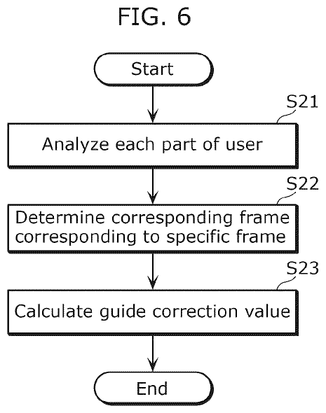

Corrector 132 calculates a guide correction value, to be used when generator 133 corrects guide image data P3, based on user image data P2 obtained through first input I/F 11 and model image data P1 obtained through second input I/F 12. The specific processing performed by corrector 132 will be described hereinafter with reference to FIG. 6.

FIG. 6 is a flowchart illustrating an example of processing by corrector 132 according to the embodiment. First, corrector 132 calculates the coordinate data of each part of user U1 in a specific frame obtained at a predetermined point in time in user image data P2 obtained through first input I/F 11 (S21). The coordinate data of each part of user U1 calculated by corrector 132 is associated with the specific frame and stored in memory 15.

Here, the specific frame may be the newest frame in user image data P2, or may be any desired frame, for example. Note that it is preferable to use the newest frame in user image data P2 as the specific frame because doing so makes it possible to calculate the guide correction value according to the newest state of user U1. The following descriptions will assume that the specific frame in user image data P2 is “frame n”. Accordingly, coordinate data L2 (n) of each part of user U1 in the specific frame is associated with the specific frame and stored in memory 15.

In step S21, like analyzer 131, corrector 132 calculates coordinate data L2 (n) of each part of user U1 in the specific frame using a suitable algorithm for detecting skeletal coordinates of a human figure included in image data, such as Kinect (registered trademark). The parts of user U1 subject to the calculation by corrector 132 are the same as the parts of the performer subject to the calculation by analyzer 131. Accordingly, here, corrector 132 calculates coordinate data of each of the head, neck, right shoulder, left shoulder, right hand, left hand, right foot, and left foot of user U1 in the specific frame.

Next, corrector 132 determines a corresponding frame corresponding to the specific frame by analyzing to which frame, among the plurality of frames of model image data P1, the specific frame corresponds (S22). The corresponding frame is the frame in which the movement of the performer most closely resembles the movement of user U1 in the specific frame.

Specifically, corrector 132 calculates difference data D12 (n+k) between coordinate data L2 (n) of each part of user U1 in the specific frame (here, “frame n” of user image data P2) and coordinate data L1 (n +k) of each part of the performer in each of 2×α+1frames of model image data P1 stored in memory 15 (where a is a natural number, k is an integer, and −α≤k≤α).

As a specific example, when α=2, corrector 132 calculates difference data D12 (n−2), D12 (n−1), and so on up to D12 (n+2) between (i) coordinate data L2 (n) of each part of user U1 in “frame n” of user image data P2 and (ii) coordinate data L1 (n−2), L1 (n−1), and so on up to L1 (n +2) of each part of the performer in “frame (n−2)”, “frame (n−1)”, and so on up to “frame (n+2)” of model image data P1.

Then, corrector 132 determines the frame in which the calculated difference data D12 (n+k) is the lowest as the corresponding frame corresponding to the specific frame. Here, the calculated difference data being the lowest corresponds to, for example, the cumulative value of the difference data of each part being the lowest. The difference data of each part here is the length of a vector indicated by the difference data, or a value corresponding to that length. For example, when the vector indicated by the difference data of each part is (dx1, dy1), the value of the difference data is dx12+dy12.

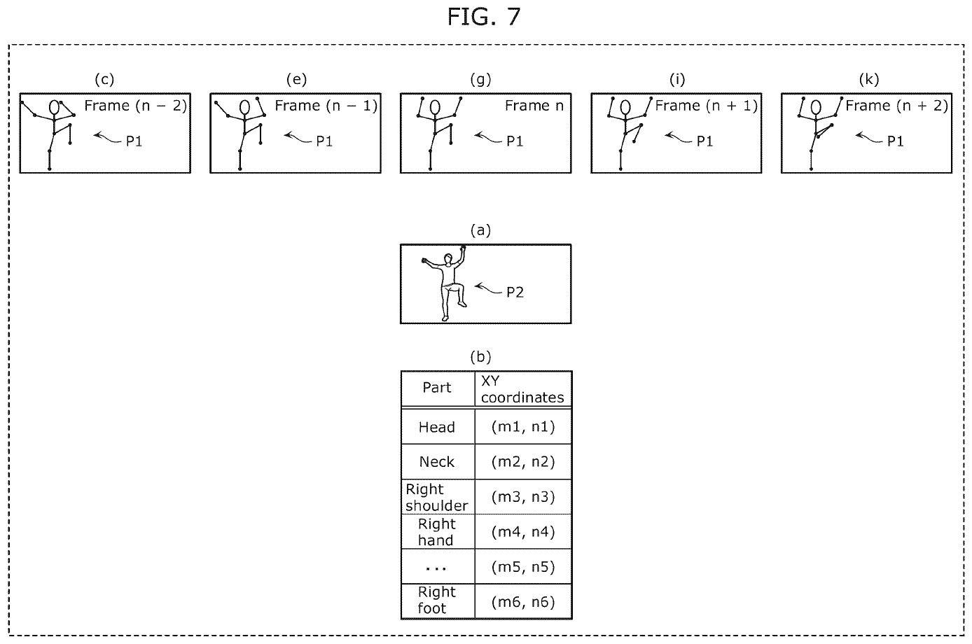

FIG. 7 is an explanatory diagram illustrating operations performed by corrector 132 according to the embodiment. (a) of FIG. 7 indicates the specific frame in user image data P2 (here, “frame n”), and (b) of FIG. 7 indicates coordinate data L2 (n) of each part of user U1 obtained by analyzing the specific frame. (c), (e), (g), (i), and (k) of FIG. 7 indicate “frame (n−2)” (k=−2), “frame (n−1)” (k=−1), “frame n” (k=0), “frame (n+1)” (k=1), and “frame (n+2)” (k=2) of model image data P1, respectively.

In (b) of FIG. 7, “part” indicates the part of user U1, and “XY coordinates” indicates the coordinates of each part of user U1 in the frame.

In the example illustrated in FIG. 7, the difference between coordinate data L2 (n) of each part of user U1 in the specific frame and coordinate data L1 (n−1) of each part of the performer in “frame (n−1)” (k=−1) of model image data P1 is the smallest. For this reason, corrector 132 determines “frame (n−1)” (k=−1) of model image data P1 as the corresponding frame.

Returning to FIG. 6, corrector 132 calculates guide correction value β1 (S23). Guide correction value β1 calculated by corrector 132 is stored in memory 15. Specifically, corrector 132 calculates guide correction value β1 based on the formula “β1=−k1”. Here, “k1” is the value of “k” when difference data D12 (n+k) mentioned above is the lowest. In other words, “k1” is calculated by subtracting the number assigned to the frame corresponding to the point in time when the specific frame of model image data P1 was obtained from the number assigned to the corresponding frame in model image data P1.

Here, guide correction value β1 indicates a time difference between the frame determined among the plurality of frames of model image data P1 (the corresponding frame) and the specific frame in user image data P2. In other words, guide correction value β1 indicates the degree to which the movement of user U1 follows the movement of the performer in model image data P1. For example, guide correction value β1 being zero indicates that user U1 is moving in time with the movement of the performer in model image data P1. On the other hand, guide correction value 31 being a positive value (i.e., “k 1 <0”) indicates that the movement of user U1 has fallen behind the movement of the performer in model image data P1. In this case, a greater absolute value of guide correction value β1 indicates a greater delay in the movement of user U1 with respect to the movement of the performer in model image data P1. Meanwhile, guide correction value β1 being a negative value (i.e., “k 1 >0”) indicates that the movement of user U1 is ahead of the movement of the performer in model image data P1. In this case, a greater absolute value of guide correction value $1 indicates that the movement of user U1 is further ahead of the movement of the performer in model image data P1.

Corrector 132 limits the value of guide correction value β1 such that offset β (described later) satisfies “β=β0+β1≥0”. “β0” represents an initial value of offset β. For example, when “β0+β1≥0”, i.e., “β0≥k1”, guide correction value β1 is “β1=k1”. On the other hand, when “β0+β1<0”, i.e., “β0<k1”, guide correction value β1 is “β1=−β0”. To give a specific example, when “β0=2” and “k1>2”, guide correction value β1 is “β1=−β0=−2”.

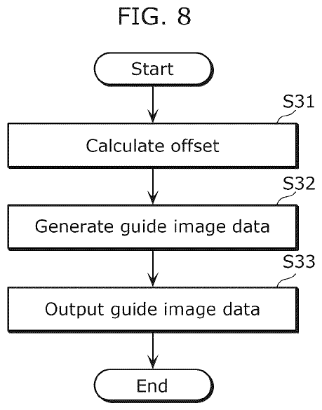

Generator 133 generates guide image data P3 based on guide correction value β1 calculated by corrector 132. The specific processing performed by generator 133 will be described hereinafter with reference to FIG. 8.

FIG. 8 is a flowchart illustrating an example of processing by generator 133 according to the embodiment. First, generator 133 calculates offset β (S31). Offset β calculated by generator 133 is stored in memory 15. Here, offset β is calculated by adding guide correction value β1, calculated by analyzing the specific frame in user image data P2, to initial value β0 of offset β, and the unit is a number of frames. In the embodiment, initial value β0 of offset β is 2 frames.

Next, generator 133 generates guide image data P3 based on offset β calculated (S32). Specifically, generator 133 determines “frame (n+1)” (“previous frame”, hereinafter) of model image data P1, corresponding to “frame (n+1)” that is the next frame after “frame n” of user image data P2 displayed on display 31, and “frame (n+1+β)” (“following frame”, hereinafter), which is the frame of model image data P1 after the previous frame by offset B. Next, generator 133 reads out, from memory 15, difference data D1 (n+1) and so on up to D1 (n+B) corresponding to each of all the frames from the previous frame to the following frame (but excluding the following frame). Then, generator 133 generates guide image data P3 based on difference D obtained by adding all of the read-out difference data D1 (n+1) and so on up to D1 (n+β). Difference D is represented by “D=D1 (n+1)+ . . . +D1 (n+β)”.

In this case, generator 133 generates an image of the arrival point in guide image data P3 for each part of user U1 based on coordinate data L1 (n+1+β) of each part of the performer in “frame (n+1+β)”, which is the following frame. Generator 133 also generates an image of an arrow in guide image data P3 for each part of user U1 based on difference D. In this manner, in the embodiment, generator 133 generates guide image data P3 by referring to the frame, among the plurality of frames of model image data P1, that is after a predetermined point in time by a length of time based on the time difference (correction value (1) (that is, by referring to the following frame).

Generator 133 then outputs guide image data P3 generated (S33). Here, generator 133 outputs guide image data P3 generated to superimposer 134.

Superimposer 134 generates, for each frame, image data in which guide image data P3 generated by generator 133 is superimposed on user image data P2 obtained through first input I/F 11. Superimposer 134 outputs the superimposed image data to compositor 135.

Compositor 135 generates, for each frame, image data obtained by compositing the image data superimposed by superimposer 134 with model image data P1 read out from memory 15. Here, compositor 135 composites the data such that the image data superimposed by superimposer 134 (i.e., user image data P2 and guide image data P3) is displayed in main screen 311 of display 31, and model image data P1 is displayed in sub-screen 312 of display 31. Compositor 135 outputs the composited image data to output I/F 14.

Output I/F 14 causes the image data composited by compositor 135 to be displayed on display 31. As a result, user image data P2 and guide image data P3 are displayed in main screen 311 of display 31, and model image data P1 is displayed in sub-screen 312. In other words, output I/F 14 causes user image data P2, model image data P1, and guide image data P3 to be displayed on display 31.

Memory 15 is a storage device that stores various types of information necessary for processor 13 to perform information processing, computer programs executed by processor 13, and the like. Memory 15 also stores user image data P2 obtained through first input I/F 11, model image data P1 obtained through second input I/F 12, the coordinate data and difference data of each part of the performer calculated by analyzer 131, guide image data P3 generated by generator 133, and the like. Memory 15 is implemented by semiconductor memory, for example.

### 2. Specific Examples

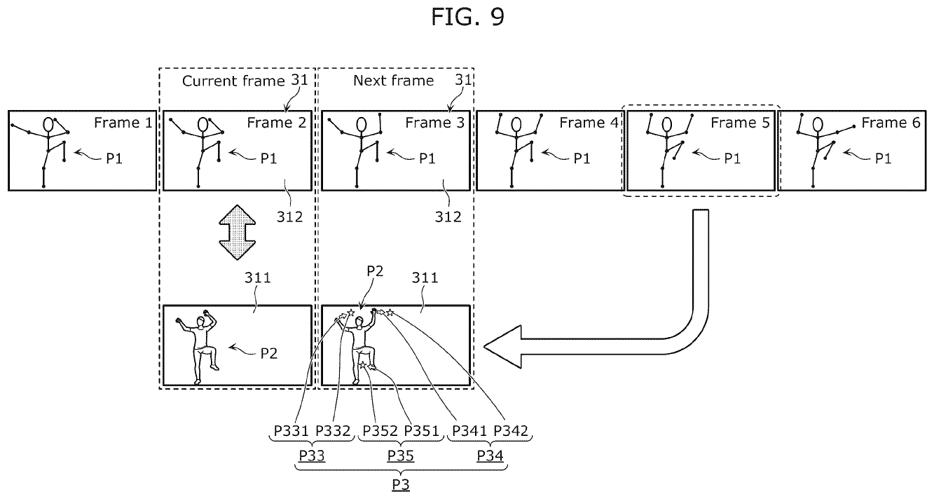

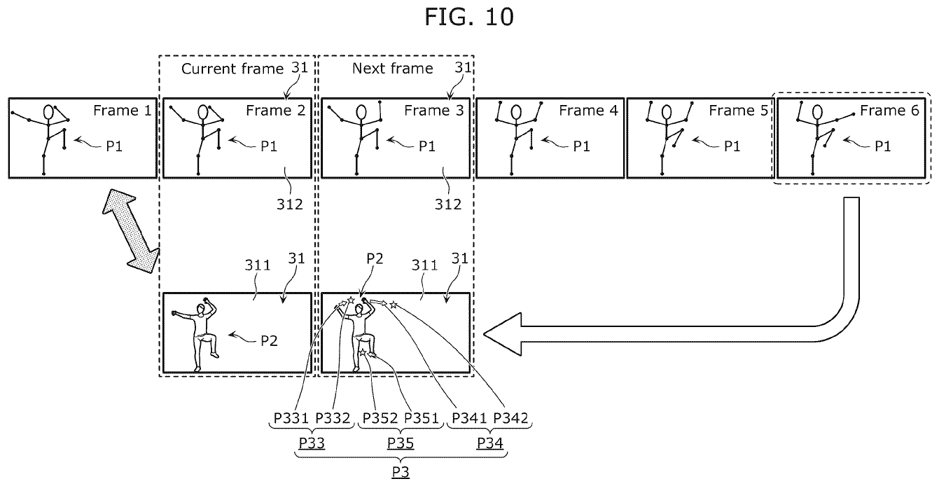

Specific examples of dance practice system 100 according to the embodiment will be described hereinafter with reference to FIGS. 9 and 10. FIG. 9 is an explanatory diagram illustrating Specific Example 1 of dance practice system 100 according to the embodiment. FIG. 10 is an explanatory diagram illustrating Specific Example 2 of dance practice system 100 according to the embodiment. In FIGS. 9 and 10, “frame 1”, “frame 2”, “frame 3”, “frame 4”, “frame 5”, and “frame 6” of model image data P1 displayed in sub-screen 312 of display 31 are illustrated in the upper part of the figures by extracting only sub-screen 312 and arranging the corresponding frames in the horizontal direction. Additionally, in FIGS. 9 and 10, “frame 2” and “frame 3” of user image data P2 displayed in main screen 311 of display 31 are illustrated in the lower part of the figures by extracting only main screen 311 and arranging the corresponding frames in the horizontal direction. Furthermore, in FIGS. 9 and 10, “current frame” indicates the frame displayed on display 31, and “next frame” represents the frame displayed on display 31 after the current frame.

Specific Example 1 illustrated in FIG. 9 illustrates a situation in which “frame 2” that is the current frame (specific frame) of user image data P2 matches “frame 2” that is the current frame of model image data P1. In other words, in Specific Example 1, the movement of user U1 is successfully following the movement of the performer without delay. For this reason, in Specific Example 1, corrector 132 of processor 13 determines “frame 2” of model image data P1 as the corresponding frame. Then, corrector 132 calculates “k1=0”. “k1” is the value of “k” when difference data D12 (n+k) is the lowest. As a result, corrector 132 calculates the guide correction value β1 as “β1=−k1=0”.

Next, generator 133 of processor 13 calculates offset β as “β=β0+β1=2”. Then, generator 133 generates guide image data P3 based on offset β calculated. Here, generator 133 determines “frame 3” of model image data P1, corresponding to “frame 3” that is the next frame after “frame 2” of user image data P2 displayed on display 31, as the previous frame. Generator 133 also determines “frame 5”, which is the frame after the previous frame of model image data P1 by offset β (here, “β=2”), as the following frame.

Next, generator 133 reads out, from memory 15, difference data D1 (3) and D1 (4) corresponding to each of all the frames from the previous frame to the following frame (but excluding the following frame). Then, generator 133 generates guide image data P3 based on difference D obtained by adding all of the read-out difference data D1 (3) and D1 (4).

In Specific Example 1, when “frame 3”, the next frame of user image data P2, is displayed on display 31, guide image data P3, which includes image data P33 corresponding to the left hand of user U1, image data P34 corresponding to the right hand of user U1, and image data P35 corresponding to the right foot of user U1, is superimposed and displayed. In Specific Example 1, arrows P331, P341, and P351 in each item of image data P33, P34, and P35 are generated with reference to difference D. Difference D is calculated by referring to difference data D1 (3) and D1 (4) corresponding to each of all of the frames (excluding the following frame) from “frame 3” of model image data P1, which is the previous frame, to “frame 5” of model image data P1, which is the following frame. Similarly, in Specific Example 1, arrival points P332, P342, and P352 in the corresponding items of image data P33, P34, and P35 are generated with reference to “frame 5” of model image data P1, which is the following frame.

User U1 moves their right hand, left hand, and right foot according to guide image data P3 while viewing guide image data P3 illustrated in FIG. 9. This makes it easier to maintain a state in which the movement of user U1 is successfully following the movement of the performer without delay.

On the other hand, Specific Example 2 illustrated in FIG. 10 illustrates a situation in which “frame 2” that is the current frame of user image data P2 matches “frame 1” that is one frame before the current frame of model image data P1. In other words, in Specific Example 2, the movement of user U1 is behind the movement of the performer by one frame. For this reason, in Specific Example 2, corrector 132 of processor 13 determines “frame 1” of model image data P1 as the corresponding frame. Then, corrector 132 calculates “k1=−1”. “k1” is the value of “k” when difference data D12 (n+k) is the lowest. As a result, corrector 132 calculates guide correction value β1 as “β1=−k1=1”.

Next, generator 133 of processor 13 calculates offset β as “β=β0+β1=3”. Then, generator 133 generates guide image data P3 based on offset β calculated. Here, generator 133 determines “frame 3” of model image data P1, corresponding to “frame 3” that is the next frame after “frame 2” of user image data P2 displayed on display 31, as the previous frame. Generator 133 also determines “frame 6”, which is the frame after the previous frame of model image data P1 by offset β (here, “β=3”), as the following frame.

Next, generator 133 reads out, from memory 15, difference data D1 (3), D1 (4), and D1 (5) corresponding to each of all the frames from the previous frame to the following frame (but excluding the following frame). Then, generator 133 generates guide image data P3 based on difference D obtained by adding all of the read-out difference data D1 (3), D1 (4), and D1 (5).

In Specific Example 2, when “frame 3”, the next frame of user image data P2, is displayed on display 31, guide image data P3, which includes image data P33 corresponding to the left hand of user U1, image data P34 corresponding to the right hand of user U1, and image data P35 corresponding to the right foot of user U1, is superimposed and displayed. In Specific Example 2, arrows P331, P341, and P351 in each item of image data P33, P34, and P35 are generated with reference to difference D. Difference D is calculated by referring to difference data D1 (3), D1 (4), and D1 (5) corresponding to each of all of the frames (excluding the following frame) from “frame 3” of model image data P1, which is the previous frame, to “frame 6” of model image data P1, which is the following frame. Similarly, in Specific Example 2, arrival points P332, P342, and P352 in the corresponding items of image data P33, P34, and P35 are generated with reference to “frame 6” of model image data P1, which is the following frame.

User U1 moves their right hand, left hand, and right foot according to guide image data P3 while viewing guide image data P3 illustrated in FIG. 10. This makes it easier for the movement of user U1 to follow the movement of the performer without delay, even if the movement of user U1 is currently behind the movement of the performer.

As described above, in dance practice system 100 according to the embodiment, when the specific frame of user image data P2 is later than the frame determined from among the plurality of frames of model image data P1 (the corresponding frame), processor 13 generates guide image data P3 by referring to model image data P1 that is earlier, in terms of time, as the time difference between the determined frame and the specific frame (correction value (1) increases. In other words, in dance practice system 100 according to the embodiment, processor 13 controls guide image data P3 to be displayed on display 31 earlier as the time difference increases.

Accordingly, in dance practice system 100 according to the embodiment, even if the movement of user U1 is delayed and cannot follow the movement of the performer, user U1 can practice the dance while viewing guide image data P3 that has been optimized according to the delay. Accordingly, dance practice system 100 according to the embodiment has an advantage in that when practicing a dance, it is easier for user U1 to imitate the movement of the performer and improve their dance proficiency.

Incidentally, in the embodiment, the reason why generator 133 of processor 13 determines “frame (n+1)”, which is the next frame after “frame n”, as the previous frame is as follows. When user image data P2 is displayed on display 31, guide image data P3 is displayed superimposed thereon, but guide image data P3 is generated by referring to an amount of change (amount of movement) from the previous frame to the following frame in model image data P1. Here, if the previous frame is determined to be “frame n”, it is necessary to execute processing for generating guide image data P3 corresponding to “frame n” before displaying “frame n” of user image data P2 on display 31. Accordingly, in this case, a delay arises from the point in time when user U1 is captured by camera 2 until “frame n” of user image data P2 is displayed on display 31.

In contrast, in the embodiment, when displaying “frame n” of user image data P2 on display 31, guide image data P3 corresponding to “frame n” generated at the point in time when “frame (n−1)”, which is the frame previous to “frame n”, is displayed on display 31, is displayed in a superimposed manner. Accordingly, in the embodiment, the delay from the point in time when user U1 is captured by camera 2 until “frame n” of user image data P2 is displayed on display 31 can be reduced. Here, guide image data P3 corresponding to “frame (n+1)”, which is the next frame, is generated while “frame n” of user image data P2 is displayed on display 31, and thus “frame (n+1)” is determined as the previous frame. Then, guide image data P3 corresponding to “frame (n+1)” can be displayed on display 31 at the timing at which “frame (n+1)” of user image data P2 is displayed.

Note that the previous frame may be determined as “frame n” and the following frame as “frame (n+β)”, but if the above delay is taken into consideration, it is preferable to determine the previous frame as “frame (n+1)” and the following frame as “frame (n+β+1)”.

### 3. Other Embodiments

Although an embodiment has been described thus far, the present disclosure is not limited to the foregoing embodiment.

In the foregoing embodiment, model image data P1 may be streamed from server 4. In this case, each time model image data P1 is obtained from server 4, processor 13 of dance practice system 100 may analyze model image data P1 obtained and display model image data P1 obtained on display 31. In this case, for each frame, analyzer 131 of processor 13 may calculate difference data D1 (n) between coordinate data L1 (n) of each part of the performer in the frame and coordinate data L1 (n−1) of each part of the performer in the previous frame.

In the foregoing embodiment, instead of user U1, user image data P2 may be displayed on display 31 as a Computer Graphics (CG) model representing user U1. In this case, by analyzing the image data generated by capturing an image using camera 2, processor 13 of dance practice system 100 may obtain data in which the posture of user U1 (the coordinates of each part of user U1) in the image data has been analyzed, and generate a CG model based on the obtained data.

In the foregoing embodiment, processor 13 may determine that user U1 has become able to successfully follow the movement of the performer when a predetermined condition is satisfied, e.g., when guide correction value 31 has been zero for at least a predetermined length of time (a predetermined number of frames). In this case, processor 13 may cause display 31 to display guide image data P3 instructing user U1 to make the movement of user U1 more closely resemble even finer movements of the performer. In other words, when the stated time difference is not greater than a threshold (here, when correction value (1 is zero), processor 13 may generate guide image data P3 based on a higher level of detail in the movement of the performer, and cause guide image data P3 to be displayed on display 31 through output I/F 14.

For example, assume that processor 13 has generated and output guide image data P3 instructing movement of the right hand of user U1 before a predetermined condition is satisfied. In this case, after the predetermined condition is satisfied, processor 13 may generate and output guide image data P3 instructing not only the movement of the right hand of user U1, but also movement of the fingers on the right hand of user U1.

In the foregoing embodiment, model image data P1 is image data indicating the movement of one performer, but model image data P1 is not limited thereto. For example, the model image data may be image data indicating movement of a plurality of performers. In this case, processor 13 may extract one performer from among the plurality of performers using a suitable image analysis algorithm, and use the image data indicating the movement of the extracted one performer as model image data P1.

In the embodiment, the analysis of model image data P1 by analyzer 131 is completed before displaying model image data P1 on display 31, but the configuration is not limited thereto. For example, the analysis of model image data P1 by analyzer 131 may be performed in parallel with the processing for displaying model image data P1 on display 31.

In the foregoing embodiment, the arrival point in guide image data P3 is a star, but is not limited thereto, and may be another shape such as a circle, or a shape resembling the hand or foot of a person. Additionally, guide image data P3 is not limited to an arrow, and may be another shape such as a triangle, or a solid or dashed line. In the embodiment, the arrival point and arrows in guide image data P3 change in terms of both the darkness and size according to the movement amount, but only one of the darkness and size may be changed. Additionally, the arrival point and arrows in guide image data P3 may have constant darknesses and sizes regardless of the movement amount.

In the foregoing embodiment, the position of sub-screen 312 is not limited to the lower-right corner of display 31, and may be elsewhere on display 31. Additionally, the shape of sub-screen 312 is not limited to a rectangular shape, and may be another shape. Furthermore, the size of sub-screen 312 may be larger or smaller than the size illustrated in FIG. 2.

Additionally, in the foregoing embodiment, dance practice system 100 is installed in computer 3, but is not limited thereto. For example, dance practice system 100 may be implemented by a server that communicates with each of camera 2 and display 31 over network N1, which is the Internet or the like. The server may be the same as or different from server 4 used for moving image delivery in the embodiment. Dance practice system 100 may also be implemented in a general-purpose information terminal, such as a smartphone or tablet terminal, for example. In this case, installing an application for dance practice system 100 in the information terminal makes it possible to implement dance practice system 100 in the information terminal. Dance practice system 100 may also be configured as a television receiver including computer 3 and display 31, for example.

Although implemented as a single device in the foregoing embodiment, dance practice system 100 may be implemented as a plurality of devices. When dance practice system 100 is implemented as a plurality of devices, the functional constituent elements included in dance practice system 100 may be distributed among the plurality of devices in any manner. Dance practice system 100 may be implemented distributed across a plurality of servers, for example. Dance practice system 100 may also be distributed between a server and computer 3, for example.

Additionally, the method through which the devices communicate with each other in the foregoing embodiment is not particularly limited. In the foregoing embodiment, when the two devices communicate, a relay device (not shown) may be provided between the two devices.

The order of the processes described in the foregoing embodiment is an example. The order of multiple processes may be changed, and multiple processes may be executed in parallel. Additionally, processing executed by a specific processing unit may be executed by a different processing unit. Additionally, some of the digital signal processing described in the foregoing embodiment may be implemented as analog signal processing.

Additionally, in the foregoing embodiment, the constituent elements may be implemented by executing software programs corresponding to those constituent elements. Each constituent element may be realized by a program executing unit such as a CPU or a processor reading out and executing a software program recorded into a recording medium such as a hard disk or semiconductor memory.

Each constituent element may be implemented by hardware. For example, each constituent element may be circuitry (or integrated circuitry). This circuitry may constitute a single overall circuit, or may be separate circuits. The circuitry may be generic circuitry, or may be dedicated circuitry.

The general or specific aspects of the present disclosure may be implemented by a system, a device, a method, an integrated circuit, a computer program, or a computer-readable recording medium such as a CD-ROM. These forms may also be implemented by any desired combination of systems, devices, methods, integrated circuits, computer programs, and recording media. For example, the present disclosure may be implemented as a dance practice method executed by a computer, or as a program for causing a computer to execute such a dance practice method. Additionally, the present disclosure may be implemented as a non-transitory computer-readable recording medium in which such a program is recorded. Note that the program here includes an application program for causing a general-purpose information terminal to function as the dance practice system according to the foregoing embodiment.

Additionally, embodiments achieved by one skilled in the art making various conceivable variations on the embodiment, embodiments achieved by combining constituent elements and functions from the embodiment as desired within a scope which does not depart from the spirit of the present disclosure, and the like are also included in the present disclosure.

### Conclusion

As described above, dance practice system 100 of a first aspect includes first input I/F 11, second input I/F 12, processor 13, and output I/F 14. Processor 13 is an example of a signal processing circuit. First input I/F 11 obtains user image data P2 that is based on image data generated by capturing image data using camera 2 and that includes a plurality of frames indicating movement of user U1. Second input I/F 12 obtains model image data P1 including a plurality of frames indicating movement of a performer serving as a model for a dance. Processor 13 generates guide image data P3 instructing user U1 to make the movement of user U1 more closely resemble the movement of the performer. Output I/F 14 causes user image data P2, model image data P1, and guide image data P3 to be displayed on display 31. Processor 13 determines which of the plurality of frames of model image data P1 corresponds to a specific frame obtained at a predetermined point in time from among the plurality of frames of user image data P2. When the specific frame is later than the frame determined from among the plurality of frames of model image data P1, processor 13 causes guide image data P3 to be displayed on display 31 earlier as a time difference between the frame determined and the specific frame is greater.

This provides an advantage in that an improvement in dance proficiency when user U1 practices a dance is facilitated.

According to dance practice system 100 of a second aspect, in the first aspect, processor 13 generates guide image data P3 by referring to a frame, among the plurality of frames of model image data P1, that is later than the predetermined point in time by a length of time based on the time difference.

This provides an advantage in that an improvement in dance proficiency when user U1 practices a dance is facilitated.

According to dance practice system 100 of a third aspect, in the first or second aspect, processor 13 causes model image data P1 to be displayed on display 31 through output I/F 14 at a timing at which movement by user U1 is desired, and causes guide image data P3 to be displayed on display 31 through output I/F 14 at a timing earlier than the timing at which movement by user U1 is desired.

This provides an advantage in that it is easier for user U1 to make their own movement follow the movement of the performer by viewing guide image data P3.

According to dance practice system 100 of a fourth aspect, in any one of the first to third aspects, at least one of a size or a darkness of guide image data P3 is changed according to a difference between the movement of user U1 and the movement of the performer. P3, it is easier for user U1 to visually understand how much to move to perform the next movement.

According to dance practice system 100 of a fifth aspect, in any one of the first to fourth aspects, when the time difference is not greater than a threshold, processor 13 causes guide image data P3 to be displayed on display 31 through output I/F 14 based on the movement of the performer shown at a higher level of detail.

This provides an advantage in that when user U1 is able to follow the movement of the performer, user U1 can be guided to imitate the movement of the performer at a more detailed level, which makes it easy to further improve the proficiency of the dance.

According to dance practice system 100 of a sixth aspect, in any one of the first to fifth aspects, guide image data P3 includes arrival points P312 to P352 indicating positions where user U1 is to arrive next on display 31, and arrows P311 to P351 indicating directions and movement amounts from a current position of user U1 to arrival points P312 to P352 on display 31.

This provides an advantage in that by viewing guide image data P3, it is easier for user U1 to visually understand what movement to perform next.

In a dance practice method of seventh aspect, user image data P2 that is based on image data generated by capturing an image using camera 2 and that includes a plurality of frames indicating movement of user U1 is obtained; model image data P1 including a plurality of frames indicating movement of a performer serving as a model for a dance is obtained; guide image data P3 instructing user U1 to make the movement of user U1 more closely resemble the movement of the performer is generated (S32); and user image data P2, model image data P1, and guide image data P3 are displayed on display 31. In the generating of guide image data P3, which of the plurality of frames of model image data P1 corresponds to a specific frame obtained at a predetermined point in time from among the plurality of frames of user image data P2 is determined (S21, S22). Then, in the generating, when the specific frame is later than the frame determined from among the plurality of frames of model image data P1 (the corresponding frame), processor 13 causes guide image data P3 to be displayed on display 31 earlier as a time difference between the frame determined and the specific frame is greater (S23, S31, S32).

This provides an advantage in that an improvement in dance proficiency when user U1 practices a dance is facilitated.

Additionally, a program of an eighth aspect causes at least one processor to execute the dance practice method of the seventh aspect.

This provides an advantage in that an improvement in dance proficiency when user U1 practices a dance is facilitated.

### Industrial Applicability

The present disclosure can be used in a system and the like for assisting dance practice by a user.

### REFERENCE SIGNS LIST

100 Dance practice system
11 First input I/F
12 Second input I/F
13 Processor (signal processing circuit)
131 Analyzer
132 Corrector
133 Generator
134 Superimposer
135 Compositor
14 Output I/F
3 Computer
31 Display
311 Main screen
312 Sub-screen
4 Server
N1 Network
P1 Model image data
P2 User image data
P3 Guide image data
P31, P32, P33, P34, P35 Image data
P311, P321, P331, P341, P351 Arrow
P312, P322, P332, P342, P352 Arrival point
U1 User

1. A dance practice system comprising:
a first input interface that obtains user image data that is based on image data generated by capturing an image using a camera and that includes a plurality of frames indicating movement of a user;
a second input interface that obtains model image data including a plurality of frames indicating movement of a performer serving as a model for a dance;
a signal processing circuit that generates guide image data instructing the user to make the movement of the user more closely resemble the movement of the performer; and
an output interface that causes the user image data, the model image data, and the guide image data to be displayed on a display,
wherein the signal processing circuit:
determines which of the plurality of frames of the model image data corresponds to a specific frame obtained at a predetermined point in time from among the plurality of frames of the user image data; and
when the specific frame is later than the frame determined from among the plurality of frames of the model image data, causes the guide image data to be displayed on the display earlier as a time difference between the frame determined and the specific frame is greater.

2. The dance practice system according to claim 1,
wherein the signal processing circuit generates the guide image data by referring to a frame, among the plurality of frames of the model image data, that is later than the predetermined point in time by a length of time based on the time difference.

3. The dance practice system according to claim 1,
wherein the signal processing circuit:
causes the model image data to be displayed on the display through the output interface at a timing at which movement by the user is desired; and
causes the guide image data to be displayed on the display through the output interface at a timing earlier than the timing at which movement by the user is desired.

4. The dance practice system according to claim 1,
wherein at least one of a size or a darkness of the guide image data is changed according to a difference between the movement of the user and the movement of the performer.

5. The dance practice system according to claim 1,
wherein when the time difference is not greater than a threshold, the signal processing circuit causes the guide image data to be displayed on the display through the output interface based on the movement of the performer shown at a higher level of detail.

6. The dance practice system according to claim 1,
wherein the guide image data includes:
an arrival point indicating a position where the user is to arrive next on the display; and
an arrow indicating a direction and movement amount from a current position of the user to the arrival point on the display.

7. A dance practice method comprising:
obtaining user image data that is based on image data generated by capturing an image using a camera and that includes a plurality of frames indicating movement of a user;
obtaining model image data including a plurality of frames indicating movement of a performer serving as a model for a dance;
generating guide image data instructing the user to make the movement of the user more closely resemble the movement of the performer; and
displaying the user image data, the model image data, and the guide image data on a display,
wherein the generating of the guide image data includes:
determining which of the plurality of frames of the model image data corresponds to a specific frame obtained at a predetermined point in time from among the plurality of frames of the user image data; and
when the specific frame is later than the frame determined among the plurality of frames of the model image data, causing the guide image data to be displayed on the display earlier as a time difference between the frame determined and the specific frame is greater.

8. A non-transitory computer-readable recording medium having recorded thereon a program for causing at least one processor to execute the dance practice method according to claim 7.
